(19) United States
(12) Patent Application Publication
(10) Pub. No.: US 2005/0121868 A1
(43) Pub. Date: Jun. 9, 2005

(54) Mobile pet food storage container

(76) Inventors: Glen Hartman, Laguna Niguel, CA (US); Marc Loehren, Costa Mesa, CA (US)

Correspondence Address: GLEN HARTMAN, 1432 HORN CANYON AVE., CHULA VISTA, CA, 91915, US

(21) Appl. No.: 10/726,749

(22) Filed: Dec. 3, 2003

(51) Int. Cl. B62B 1/00

(52) U.S. Cl. 280/47.26

(57) ABSTRACT

A Mobile Pet Food Storage Container is disclosed. The container has a movable platform for placing bagged or loose pet food thereon. The height of the platform raises or lowers, depending upon the quantity of food remaining on the platform. The container further has wheels and a retractable handle such that it can be conveniently transported. Still further, the container has at least one tray extendable from the front of the container that is further capable of being foldably stowed. Finally, the container has a pocket extending from a side wall of the container.

### BACKGROUND OF THE INVENTION

1. Field of the Invention

This invention relates generally to pet food storage containers and, more specifically, to a Mobile Pet Food Storage Container

2. Description of Related Art

Most modern households these days have one or more pets, with cats and dogs being generally the most popular type. In an effort to cut the cost of caring for their pets, many pet-owners will purchase large bags of dry pet food for feeding to the pet. An example of these packages is depicted in FIGS. 1A and 1B. The typical vendor-supplied bulk dry pet food package 10 is a large paper bag 12 that has a folded seal at its top. These packages 10 can typically range from 10 to 50 pounds in weight. The dry food 18 is dispensed out of the top 14 of the bag 12 through the opening 16 formed in the bag's top.

The numerous problems associated with these large bulk food packages 10 sometimes outweigh their advantages, namely: (1) they are so bulky that it is difficult to find a convenient location to store them, while still being able to get at the opening 16 to get out the food 18; (2) since they are so heavy, they are difficult to transport, such as when the family travels with their pet; (3) the folded top seal is not airtight—this allows that food to be accessed by insects and rodents, particularly since the typical storage locale for the package 10 is the garage, where these vermin have easy access; and (4) the package 10 does not provide a convenient position to dispense the food 18 from the bag 12 and into the pet's dish—many times the pet-owner must have an intermediate storage receptacle (e.g. a demoted water pitcher) for dispensing food into the pet's dish, because they lack the coordination necessary to get food 18 out of the bag 12 without spilling.

What is needed, therefore, is a conveniently movable, vermin-proof pet food storage container that also provides a convenient place to dispense food from a vendor bulk package 10 into the pet's dish.

### SUMMARY OF THE INVENTION

In light of the aforementioned problems associated with the prior devices, it is an object of the present invention to provide a Mobile Pet Food Storage Container. The container should have movable platform for placing bagged or loose pet food thereon. The height of the platform should raise or lower depending upon the quantity of food remaining on the platform. The container should further have wheels and a retractable handle such that it can be conveniently transported. Still further, the container should have at least one tray extendable from the front of the container; the tray should further be capable of being foldably stowed. Finally, the container should have a pocket extending from a side wall of the container.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings, of which:

FIGS. 1A and 1B are perspective views of a conventional vendor bulk dry pet food storage package;

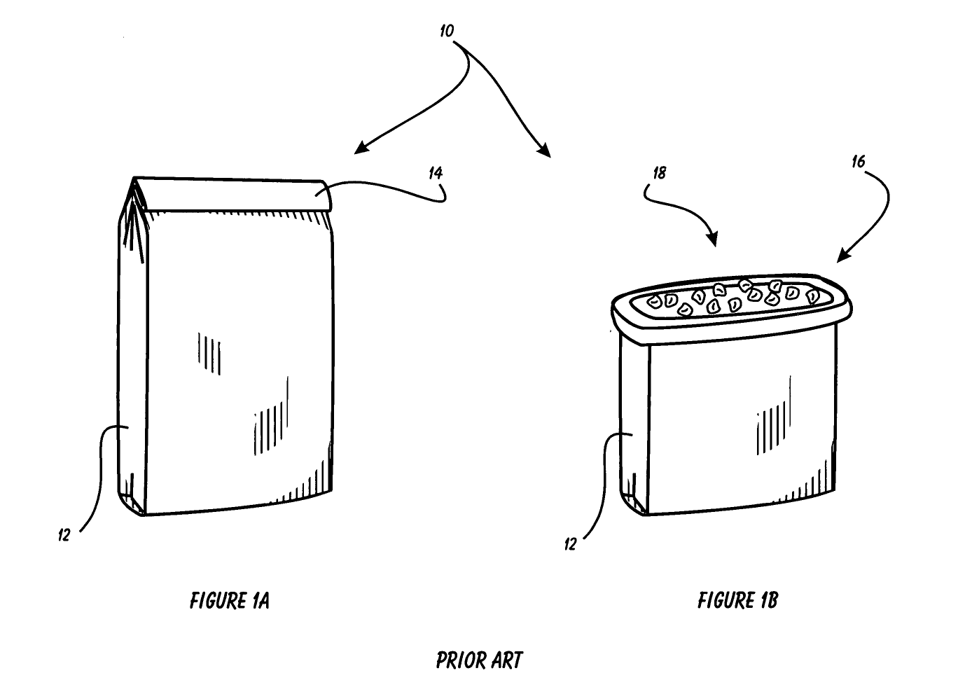

FIG. 2 is a perspective view of a preferred embodiment of a pet food dispensing container of the present invention;

FIG. 3 is a side view of the container of FIG. 2;

FIG. 4 is a cutaway side view of the container of FIGS. 2 and 3;

FIG. 5 is a cutaway side view of the container of FIGS. 2-4 having a full vendor package resting therein; and

FIG. 6 is a cutaway side view of the container of FIGS. 2-5 having a partially full vendor package resting therein.

### DETAILED DESCRIPTION OF THE PREFERRED EMBODIMENTS

The following description is provided to enable any person skilled in the art to make and use the invention and sets forth the best modes contemplated by the inventor of carrying out his invention. Various modifications, however, will remain readily apparent to those skilled in the art, since the generic principles of the present invention have been defined herein specifically to provide a Mobile Pet Food Storage Container.

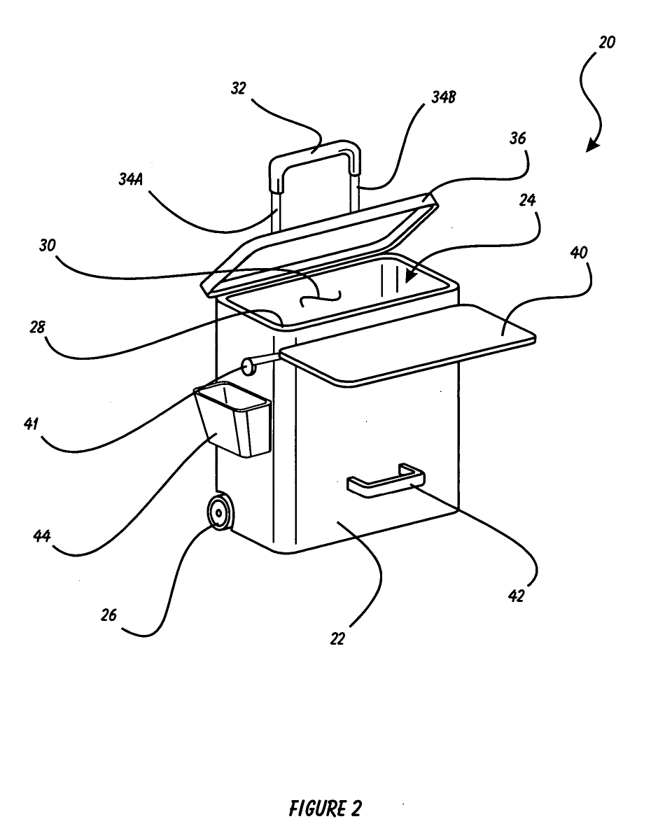

The present invention can best be understood by initial consideration of FIG. 2. FIG. 2 is a perspective view of a preferred embodiment of a pet food dispensing container 20 of the present invention. The container 20 comprises a housing 22, typically constructed from metal, or alternatively, molded plastic; the housing 22 defines a main chamber 24 and typically will have a pair of wheels 26 extending therefrom (only one wheel shown) to enable the container 20 to be rolled around.

The housing 22 further has a rim 28 at its top end that defines an opening 30 through which the pet-owner can gain access to the main chamber 24. To assist in moving the container 20 from place to place, a first handle 32 extends from the housing 22 from a pair of struts 34A and 34B. These struts 34 will typically collapse telescopically into the rear of the housing 22 in order to provide a condensed size.

The container 20 has a (typically molded plastic) lid 36 hingeably attached to the top of the housing, in the vicinity of the rim 28. The lid 36 can be closed to provide a substantially air-tight (and vermin-proof) seal to the opening 30, as will be discussed more fully below.

On the depicted embodiment of the container 20, there is a folding tray 40 that can be extended out from the front of the housing 22. The tray 40 attaches to the housing by attachment devices 41, such as the pivoting hinge connections, of which one is shown here. The operation of the tray 40 will be provided below in connection with other drawing figures.

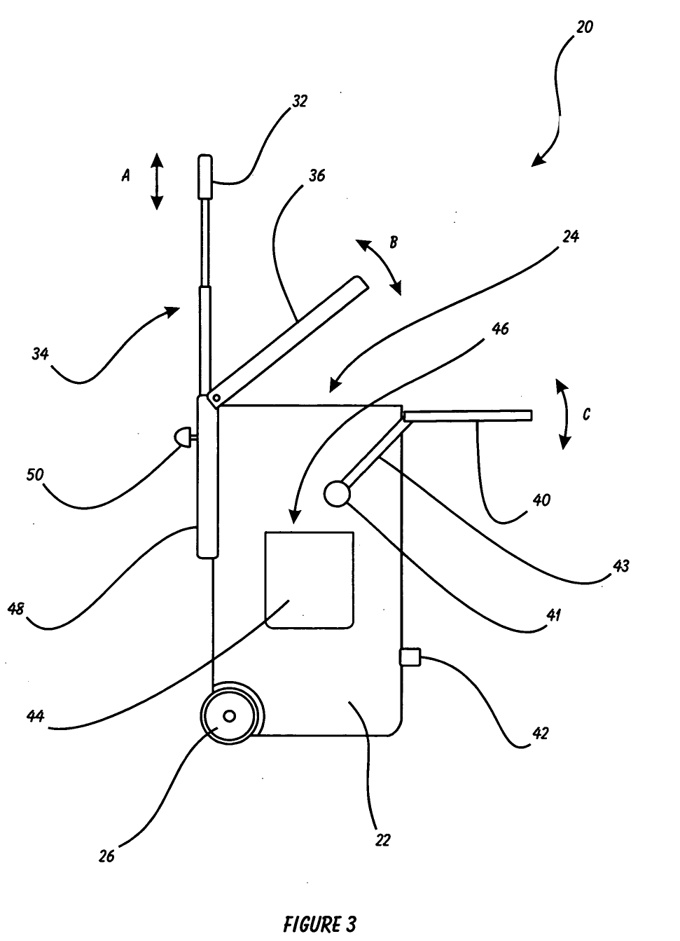

A second handle 42 may be provided on the front of the housing 22 in order to allow the container 20 to be picked up more easily, such as to load or unload from a vehicle. Finally, one or more auxiliary containers 44 may be attached (possibly detachably) to the side(s) of the housing 22 in order to provide the pet-owner with a convenient storage receptacle for other pet items, such as snacks, toys, leashes, etc. A scoop for assisting in the dispensing of pet food may also be held in the auxiliary container(s). Now turning to FIG. 3, we can examine other aspects of the present invention.

FIG. 3 is a side view of the container 20 of FIG. 2. As shown, the first handle 32 is attached to the housing 22 by one or more telescoping struts 34. The telescoping nature of the struts 34 permits the first handle 32 to be extended or retracted along direction “A” when the user desires. When retracted, the struts 34 slip into one another and into the strut housing 48 formed or attached to the rear side of the housing 22.

A rubber (or other resilient material) bumper 50 may be provided to extend rearwardly from the housing so that exterior structures are not dented and scraped by the container 20 when it is being handled. As discussed previously, the lid 36 can hingably move from an opened to a closed position along arc “B.”

The tray 40 extends from the attachment devices 41 by a pair of arms 43. The pivoting nature of the attachment devices 41 permits the tray to travel through arc “C.” In its lowered position, the tray 40 will lay substantially flat against the front of the housing 22. When extended, the tray 40 can be locked into place in the position shown here, thereby creating a convenient work surface for the user.

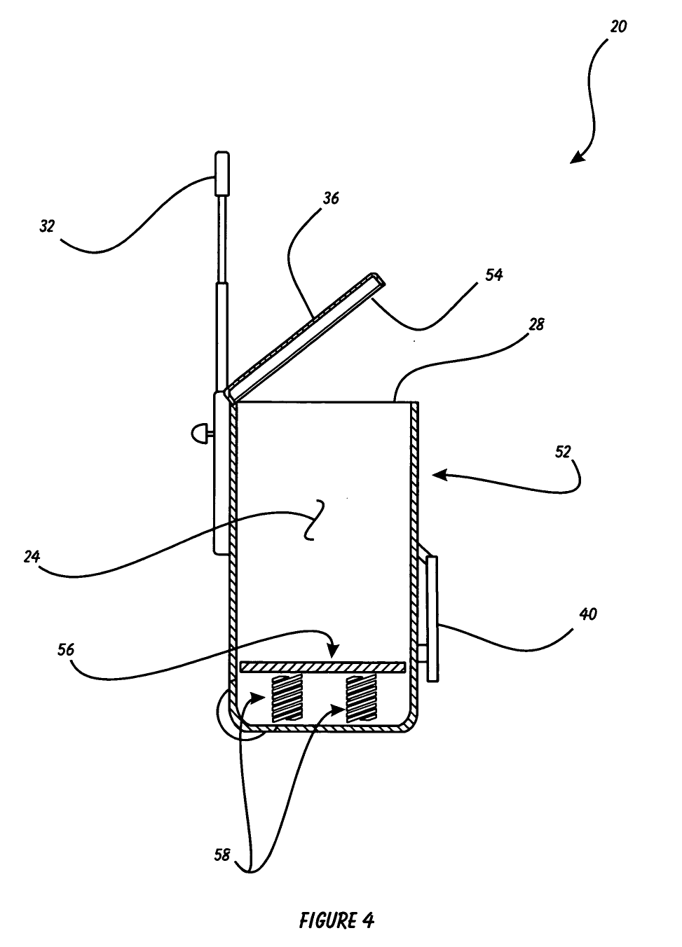

Also shown here is one of the auxiliary containers 44 mounted to the side of the housing 22; the container 44 forms an auxiliary chamber 46 therein that may or may not be sealable (such as with a lid, not shown). Turning to FIG. 4, we can continue to examine the device of the present invention.

FIG. 4 is a cutaway side view of the container 20 of FIGS. 2 and 3. The main chamber 24 is essentially a hollow cavity bounded on four sides by the rear wall, side walls, and front wall 52 of the housing 22. The bottom of the chamber 24, however, is formed by a platform 56. The platform 56 is attached to the housing 22 (typically the bottom thereof) by device(s) that will raise or lower the platform 56 in order to provide convenient dispensing of the pet food from a vendor package. In this depicted version, the raising/lowering devices are biasing devices 58, namely springs, pistons, or other conventional devices. As designed, the biasing devices 58 will create an upward force to suspend the platform 56 at some level above the bottom of the housing.

In order to provide a substantially air-tight seal, the lid 36 may be equipped with a gasket 54 around its periphery for sealing to the rim 28 when the lid 36 is in the closed position.

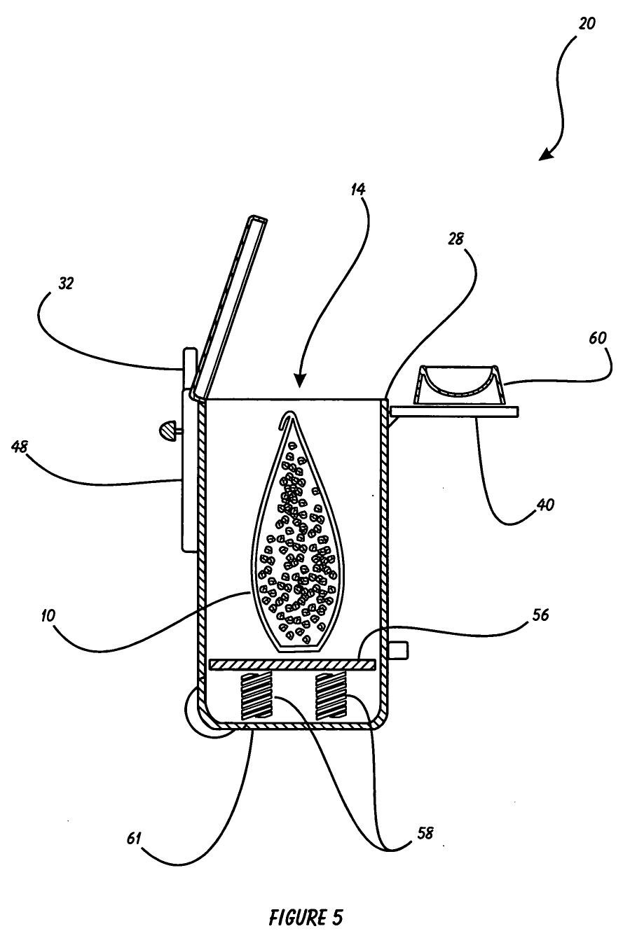

As is further shown here, the tray 40 is in its “stowed” position, i.e., it is folded flat against the front wall 52 of the housing 22. FIG. 5 shows the invention in use.

FIG. 5 is a cutaway side view of the container 22 of FIGS. 2-4 having a full vendor package 10 resting therein. The substantial weight of the full package 10 resting on the platform 56 causes the biasing devices 58 to compress, thereby lowering the platform 56 (and package 10) towards the bottom wall 61. In other non-depicted embodiments, the biasing devices 58 may be replaced with a mechanism that allows the user to manually raise or lower the platform. In one embodiment, the housing 22 is designed to accept an entire package of pet food (rather than loose food dumped into the chamber) for two reasons: (1) it is much easier to keep the inside of the chamber clean this way, and (2) packaged bulk dry food is more readily available (and easier to handle) than loose dry food. For alternative embodiments, the biasing mechanism may be modular and removable for cleaning—this would permit the dumping of loose food directly into the container.

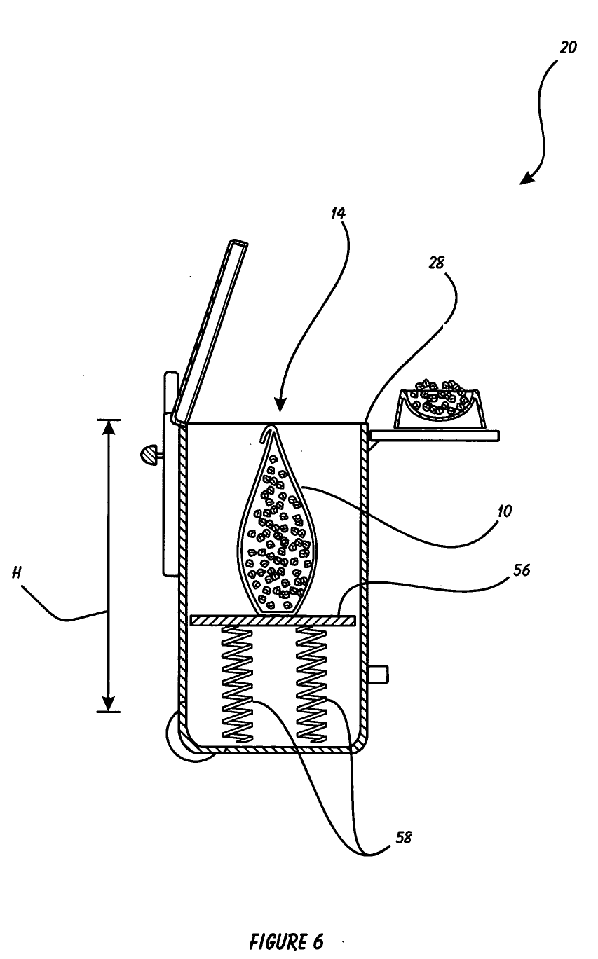

In this Figure, the tray 40 has been locked in the “up” position; here, the pet-owner can place the pet's food dish 60 on the tray 40 while food is scooped or otherwise dispensed from the top 14 of the large package 10 and into the dish 60. It should also be noted that the telescoping struts have been retracted into the strut housing 48, such that the first handle 32 is in its “down” position. Finally turning to FIG. 6, we can see how the container reacts as food is dispensed from the package 10.

FIG. 6 is a cutaway side view of the container of FIGS. 2-5 having a partially full vendor package resting therein. As shown, the package 10 has been emptied somewhat of food; as food is taken out of the package 10, the weight is reduced. As the weight is reduced, the biasing devices 58 will force the platform 56 (and package) higher and higher along the height “H” of the main chamber. The purpose for this is to make the top 14 of the package 10 at or as near as possible to the same level as the rim 28 of the housing 22—this provides for less stooping and effort on the part of the pet-owner when food is being dished out.

Those skilled in the art will appreciate that various adaptations and modifications of the just-described preferred embodiment can be configured without departing from the scope and spirit of the invention. Therefore, it is to be understood that, within the scope of the appended claims, the invention may be practiced other than as specifically described herein.

1. A pet food storage container, comprising:
a housing defining a main chamber and an opening for accessing said opening, said main chamber defining a height;
a platform movable along said height; and
a lid configured to cooperate with said housing to close said opening.

2. The container of claim 1, wherein said housing further comprises at least one rolling means for enabling said housing to be rolled disbursed on said housing.

3. The container of claim 2, further comprising a first handle extending generally upwardly from said housing.

4. The container of claim 3, further comprising elevation adjusting means attached between said platform and said housing, said elevation adjusting means configured to move said platform along said height.

5. The container of claim 4, wherein said elevation adjusting means comprises at least one biasing device.

6. The container of claim 1, further defined by a tray extending from said housing.

7. The container of claim 6, wherein said housing is defined by a pair of side walls and said tray further comprises an attachment device attached to each said side wall.

8. The container of claim 7, wherein said attachment devices comprise pivotable connections between said tray and said side walls.

9. The container of claim 7, wherein said housing is further defined by a front wall, said container further comprising a second handle extending from said front wall.

10. The container of claim 9, further comprising at least one auxiliary container disposed on at least one said side wall or front wall.

11. A combination vendor pet food package and mobile pet food storage container, the combination comprising:
a vendor pet food package comprising a bag defined by a bottom, a top and an opening at said top; and
a mobile pet food storage container comprising a housing defining a main chamber, at least one wheel extending from said housing and a platform configured for resting said package thereon, said platform attached to said housing in said main chamber.

12. The combination of claim 11, wherein said mobile pet food storage container further comprises a tray hingeably attached to said housing.

13. The combination of claim 12, wherein said housing is further defined by a rim creating an opening for accessing said main chamber, said mobile pet food storage container further comprising a lid attached to said housing.

14. The combination of claim 13, wherein said lid further comprises a sealing gasket means for creating an airtight seal between said lid and said housing.

15. The combination of claim 14, wherein said mobile pet food storage container further comprises a first handle, said first handle attached to said housing by at least one telescoping strut extendable therefrom.

16. A mobile pet food storage container, comprising:
a housing defining a main chamber and an opening for accessing said opening, said main chamber defining a height;
a platform movable along said height;
elevation adjusting means attached between said platform and said housing, said elevation adjusting means configured to move said platform along said height;
a tray extendable from said housing; and
a lid configured to cooperate with said housing to close said opening.

17. The container of claim 16, wherein said housing is defined by a pair of side walls and said tray further comprises an attachment device attached to each said side wall.

18. The container of claim 17, wherein said attachment devices comprise pivotable connections between said tray and said side walls.

19. The container of claim 18, wherein said housing further comprises at least one rolling means for enabling said housing to be rolled disbursed on said housing.

20. The container of claim 19, further comprising a first handle extending generally upwardly from said housing.
